(19) United States
(12) Patent Application Publication
(10) Pub. No.: US 2005/0114222 A1
(43) Pub. Date: May 26, 2005

(54) Method and system for providing a shipping label via an electronic procurement system

(75) Inventor: Steve Mundy, El Dorado Hills, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/719,679

(22) Filed: Nov. 21, 2003

(51) Int. Cl. G06F 17/60

(52) U.S. Cl. 705/26

(57) ABSTRACT

Methods and systems are disclosed for providing shipping services via an electronic procurement or spend management system. A user logged into an electronic procurement or spend management system can choose to purchase shipping services. The disclosed system and method solicit information from the user regarding the package to be shipped. Upon the user entering the required information the system is configured to send a pre-paid, printable, electronic shipping label to a buyer interface accessible by the user. The user can then print the electronic label and attach the printed label to the package to be shipped. The purchase of the shipping services is recorded in the electronic procurement or spend management system enabling the purchase to be tracked like the purchases of goods made via an electronic procurement or spend management system.

### BACKGROUND OF THE INVENTION

1. Field of the Invention

This invention is directed to a system and method for providing shipping services. This invention also relates to spend management or e-procurement systems.

2. Description of Related Art.

Businesses, whether large or small, often have a number of employees whose responsibilities include purchasing goods from outside firms in the course of performing their job duties. The larger the business, the more employees the business is likely to have with such responsibilities. These purchases can cover a wide spectrum of products and services. From buying office supplies, such as pens and paper, to purchasing desktop computers and large servers, to obtaining the raw materials needed to produce an article of manufacture, each of these purchases affects the bottom line of the purchasing business. All but the smallest of operations have policies in effect for employees to follow in making purchases. Accurate records are crucial to, for example, determining the profit of the business, filing proper tax returns, tracking company funds, and discovering inefficiencies. In light of recent corporate bankruptcies and the subsequent enactment of the Sarbanes-Oxley Act these records have an even greater importance to public corporations in providing accountability within the organization of a company.

A given company's purchasing policies may cover, among other things, proper authorization procedures, record-keeping requirements, and preferred or even exclusive providers of a particular type of product. Limiting purchases to a list of preferred or exclusive businesses has the benefit of allowing a company to limit purchased products and services for a number of reasons. For example, the purchasing company's information technology department may have particular expertise in servicing a certain brand of computer, or they may have determined that one brand is superior in quality to another. Standardizing to one brand of product across the enterprise can avoid future problems related to the stocking of surplus repair parts or unforeseen issues with interoperability. Among the many potential advantages to limiting suppliers from which employees can purchase goods and services is that the purchasing business can negotiate preferred pricing arrangements with potential suppliers. By consolidating the purchasing power of the entire company, significant savings may be obtained though leveraging this to the company's advantage.

Even with a strong set of procurement policies in place, purchases that do not comply with the rules, sometimes referred to as “maverick” purchases, are still possible. Employees may view the procedures as unnecessary “red tape”, or have negative personal opinions regarding an exclusive provider of a certain product. Perhaps the maverick employee sincerely believes he or she is getting a better product for the company by avoiding the procurement policy.

The “red tape” associated with paperwork methods of enforcing a procurement policy can, however, be substantial. Also, even if the policies are followed to the letter, the potential exists for the data regarding the purchase to never be received by management due to, for example, loss of the documents, or prohibitive data entry costs.

Computerized systems have been developed to alleviate the hassles that can be associated with maintaining a business procurement policy and to maximize access to data regarding business purchases. These systems provide a computerized interface through which company employees can procure goods. The system can be used to enforce the procurement policies of a given company. For example, appropriate approval may be required before the system will complete an order, and the list of potential suppliers can be limited to only the preferred suppliers. The price offered through the system can be set as the price negotiated by the purchasing company and the supplying company. The systems can maintain detailed records of all purchasing transactions, allowing funds to be tracked with accuracy. The computerized interface provided to the buying company can be linked with computerized interfaces provided to a number of suppliers over a large network, such as the Internet. The supplier interface allows the supplier to, for example, enter available inventory, set prices, and view sales.

Related systems are disclosed in U.S. Pat. Nos. 6,125,391, 6,226,675, 6,285,989, 6,542,912, 6,584,451, 6,591,260, and 6,606,603. These patents provide background information relevant to understanding the present invention and are incorporated herein by reference.

While manufactured goods can be obtained through these systems, many types of services are generally not offered. Specifically, shipping services are not offered through the online spend management or e-procurement systems. Of course, when goods are purchased through the system, the goods are commonly shipped to the buyer from the supplier. Shipping arrangements are generally handled on the supplier side of the transaction. This is suitable for delivering purchased goods, but does not allow a company to purchase shipping services in order to send outgoing packages from that business. Therefore a system and method are needed for providing shipping services via an online spend management or electronic procurement system that allows a business to purchase shipping services for outgoing packages.

### BRIEF SUMMARY OF THE INVENTION

The methods, apparatuses, systems, and articles of the invention, in their various embodiments and aspects, overcome the disadvantages of previous technologies, including those identified above.

According to one embodiment of the invention, a method comprises accepting a request for shipping services made from a buyer interface of an electronic procurement system and returning an electronic shipping label to the buyer interface.

According to another embodiment of the invention, a system comprises a shipping carrier procurement services server configured to accept a request for shipping services from a buyer interface of an electronic procurement system and further configured to return an electronic shipping label to the buyer interface.

According to yet another embodiment of the invention, a method comprises offering shipping services to a user of an electronic procurement system, and returning an electronic shipping label to the user. A user of the electronic procurement system can print the electronic shipping label, and place the label on the package to be shipped. A user can access the electronic procurement system using a buyer interface. The buyer interface can present the user with the option of purchasing shipping services. The option of purchasing shipping services can be presented by, for example, displaying the name of a shipping carrier. The option of purchasing shipping services can be presented along with the option to buy other goods and services in a selectable list. The electronic procurement system can save a record of the purchase so that the company purchasing the shipping services can track the company's use of funds.

In an addtional embodiment of the invention, a method comprises shipping a package by purchasing shipping services through an electronic procurement system and receiving an electronic shipping label. The label can then be printed out and attached to the package to be shipped. The package is then ready for pickup by the shipping carrier to take the package to its destination.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a system architecture for implementation of the present invention in accordance with an exemplary embodiment.

FIG. 2 illustrates the steps of a transaction method made in accordance with an exemplary embodiment of the invention.

FIG. 3 illustrates a procurement application login screen in accordance with an exemplary embodiment of the invention.

FIG. 4 illustrates a procurement application menu screen in accordance with an exemplary embodiment of the invention.

FIG. 5 illustrates a procurement application supplier selection screen in accordance with an exemplary embodiment of the invention.

FIG. 6 illustrates data transferred from a buyer procurement server to a shipping carrier procurement services server in the transaction according to an exemplary embodiment of the invention.

FIG. 7 illustrates a cXML formatted page that can be used to facilitate the data transfer from a buyer procurement server to a shipping carrier procurement services server according to an exemplary embodiment of the invention.

FIG. 8 illustrates data transferred from a shipping carrier services server to a buyer procurement server in the transaction according to an exemplary embodiment of the invention.

FIG. 9 illustrates a cXML formatted page that can be used to facilitate the data transfer from a shipping carrier services server to a buyer procurement server according to an exemplary embodiment of the invention.

FIG. 10 illustrates a shipping services check out screen according to an exemplary embodiment of the invention.

FIG. 11 illustrates a pre-paid shipping label returned to the buyer according to an exemplary embodiment of the invention.

FIG. 12 illustrates data transferred from a shipping carrier services server to a buyer procurement server for recording a purchase of shipping services in the transaction according to an exemplary embodiment of the invention.

FIG. 13 illustrates a cXML formatted page that can be used to facilitate the data transfer from a shipping carrier services server to a buyer procurement server for recording a purchase of shipping services in the transaction according to an exemplary embodiment of the invention.

FIG. 14 illustrates an example list of information that can be sent from the shipping carrier procurement services server to the shipping carrier tracking system and/or the shipping carrier billing system.

FIG. 15 illustrates the process of providing shipping services according to the present invention.

FIG. 16 illustrates the process of purchasing shipping services according to the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

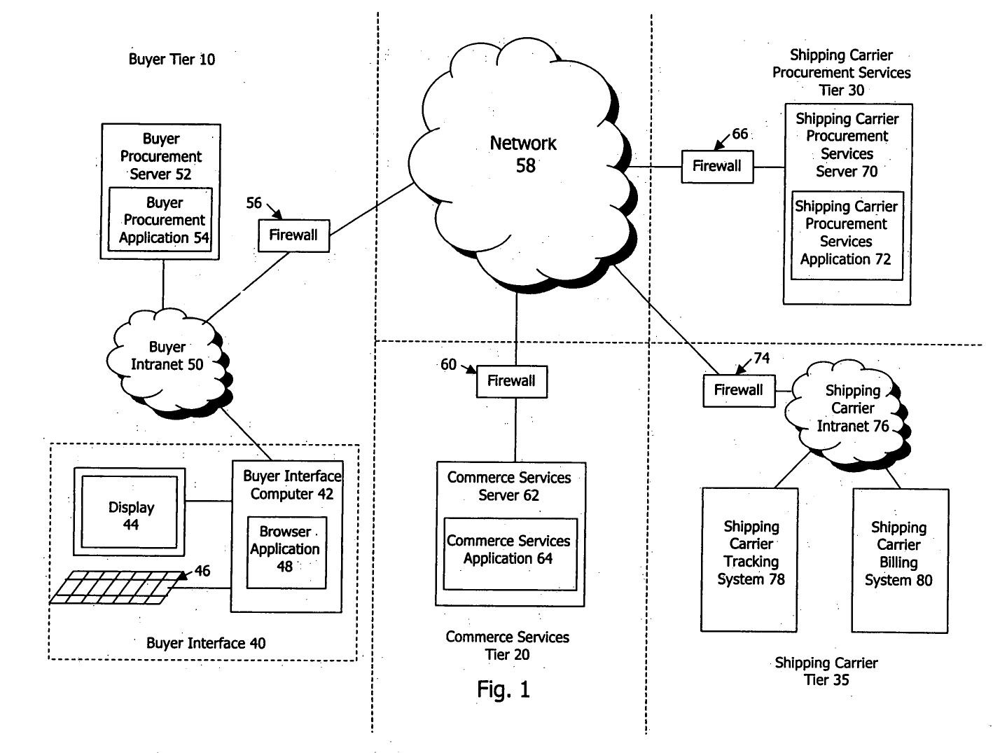

FIG. 1 illustrates a system architecture for implementation of the present invention in accordance with an exemplary embodiment. A buyer interface 40 having a buyer interface computer 42, display 44 and one or more input devices such as a keyboard 46 and mouse (not shown) is communicatively connected a network such as buyer intranet 50. The buyer interface may comprise a personal computer, a personal data assistant (PDA) or any other device capable of allowing a user to communicate over a computer network. In the case of the user interface comprising a personal computer, the computer comprises a central processing unit (CPU), random access memory (RAM), a system bus and/or motherboard, video output device, and network interface card (NIC). The computer preferably also comprises a storage device such as a hard drive for storing and retrieving data, but can alternatively be configured to boot an operating system (OS) from a network device. The computer is configured to run an OS such as Microsoft Windows or Linux, for example. Likewise, a PDA or any other type of device used as the buyer interface will have the OS, software and/or firmware necessary to enable communication with other devices via a network. The buyer interface is capable of communicating with other devices via a network protocol such as TCP/IP, for example. In a preferred embodiment, the user interface includes a web browser such as Microsoft Internet Explorer or other web browsers known in the art. As with all electronic communications discussed herein, the communication between the buyer interface and the buyer intranet may occur via a hardwired network or via wireless communication.

A buyer procurement server 52 running a buyer procurement application 54 is also connected to the buyer intranet. The buyer intranet comprises a network that allows the buyer interface computer to communicate electronically with the buyer procurement server. There can be a number of buyer interfaces connected to the buyer intranet to allow purchases to be made from a number of different locations in a company and/or to allow purchases to be made by a number of employees. In an alternate configuration, the buyer interface computer executes the buyer procurement application locally.

The buyer procurement server can comprise a CPU, RAM, system bus, storage device, and NIC. The server can also comprise an operating system such as Microsoft Windows, Linux, or other operating systems known in the art. The buyer procurement application 54 is an e-procurement/spend management application such as those offered by Ariba and Commerce One. The application is configured to list preferred suppliers of goods and services, execute purchase transactions, and record transaction information regarding purchases made including but not limited to descriptions of the products or services purchased, an identification of the employee who made the purchase, the price of the purchase, and the time of the purchase. The buyer procurement application may also be configured to store and retrieve detailed information regarding goods and services provided by a given supplier.

The buyer intranet is communicatively connected to a network 58 such as the Internet. A firewall 56 comprising hardware or software or both can be used to isolate the buyer intranet from the network 58 to prevent unauthorized access as is well known in the art. A commerce services server 62 is communicatively connected to the network 58. A firewall 60 comprising hardware or software or both can be used to isolate the commerce services server from the network 58 to prevent unauthorized access as is well known in the art. In addition, a local area network (not shown) may exist between the firewall 60 and the commerce services server.

The commerce services server can run a commerce services application 64. The commerce services application is an electronic procurement or spend management application such as those offered by Ariba and Commerce One, for example. The commerce services server is configured to store supplier information, including but not limited to, supplier name, supplier location, descriptions of products and/or services offered, authentication keys for verifying the sources of data, and product pricing information.

A shipping carrier procurement services server 70 is communicatively connected to the network 58. A firewall 66 comprising hardware or software or both can be used to isolate the shipping carrier procurement services server from the network 58 to prevent unauthorized access. In addition, a local area network (not shown) may exist between the firewall 66 and the shipping carrier procurement services server. The shipping carrier procurement services server can comprise a CPU, RAM, system bus, storage device, and NIC. The server can also comprise an operating system such as Microsoft Windows, Linux, or other operating systems known in the art. The shipping carrier procurement services server runs a shipping carrier procurement services application 72. It should be noted that a standalone server is not required to run the shipping carrier procurement services application. The shipping carrier procurement services application can be run along with a number of other programs on a shared server. In addition, the shipping carrier procurement services application is not necessarily a standalone program. The shipping carrier procurement services application can be a module within a larger program such as a shipping carrier tracking system, for example.

In the embodiment shown in FIG. 1, a shipping carrier intranet 76 is connected to the network 58, though a firewall 74. The firewall 74 can comprise hardware or software or both and can be used to isolate the shipping carrier intranet from the network 58 to prevent unauthorized access. A shipping carrier tracking system 78 and a shipping carrier billing system 80 are connected to the shipping carrier intranet. The shipping carrier tracking system and a shipping carrier billing system are not required to be on separate servers. These two systems could also be integrated into a single system. The shipping carrier tracking system can allow packages being shipped by the shipping carrier to be tracked via the Internet. The shipping carrier tracking system can also be configured to accept package data and create labels for packages to be shipped by the shipping carrier. The shipping carrier billing system can be configured to calculate shipping charges for shipping a package from an origin address to a destination address. The shipping carrier billing system can also be configured to record purchases of shipping services and generate bills for shipping services.

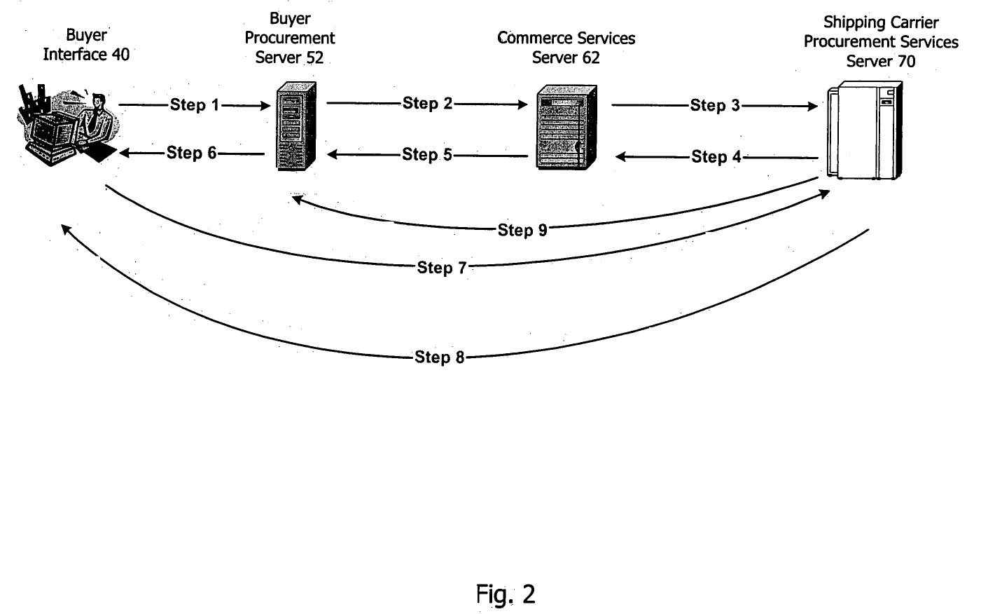

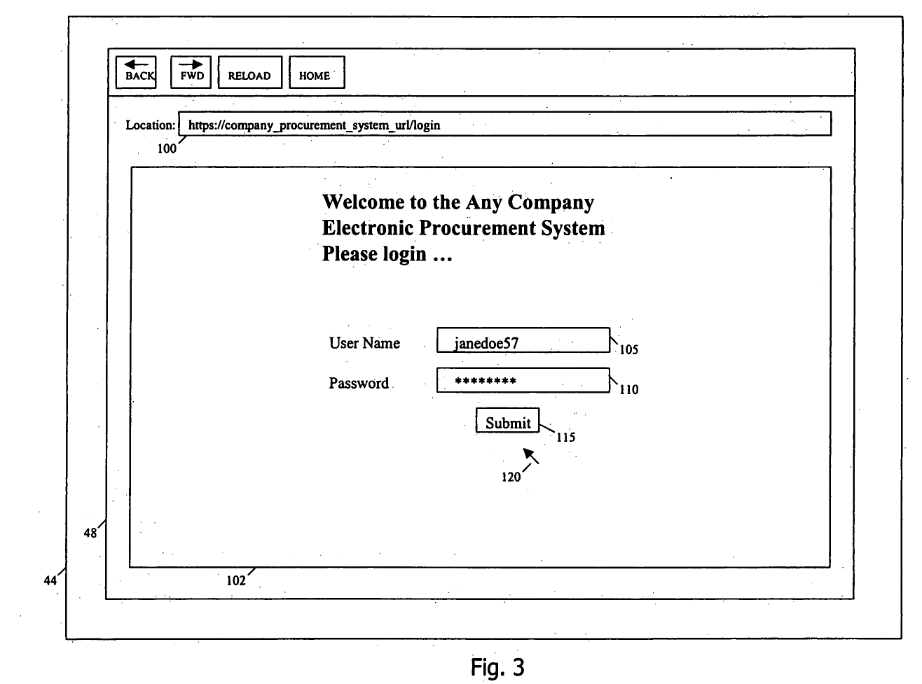

FIG. 2 illustrates the data transfer steps that occur in an exemplary embodiment of the invention. At step 1, a user of the system points the browser application 48 of the buyer interface 40 to a uniform resource locator (URL) and/or uniform resource identifier (URI) corresponding to the buyer procurement application 54 running on the buyer procurement server 52. (The term URL will be used hereafter to refer to URL and/or URI.) The URL can be entered on the “Location” line 100 of the web browser application 48 shown on display 44 depicted in FIG. 3. The URL is mapped to an IP address of the buyer procurement server in a Domain Name Server (DNS) connected to the buyer intranet 50. The DNS server looks up the URL and returns the corresponding IP address as is well known in the art. Alternatively the user could point the browser application to the buyer procurement server by typing the IP address directly into the browser. The browser application then contacts the buyer procurement application running on the buyer procurement server. The buyer procurement application can respond to network requests or can have an integrated web server application, or a web server application may run on the buyer procurement server concurrently with the buyer procurement application.

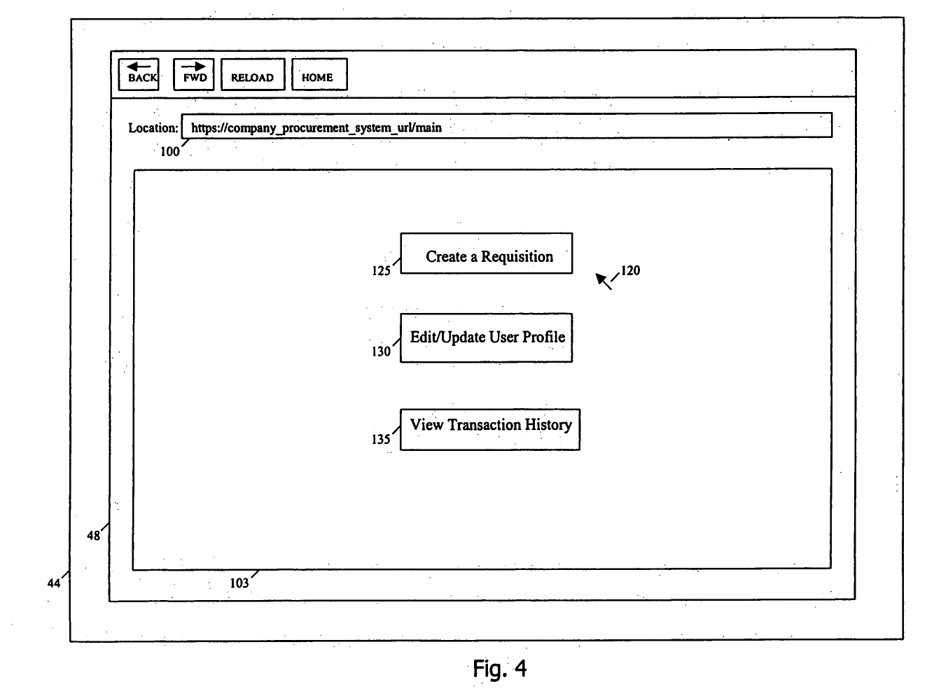

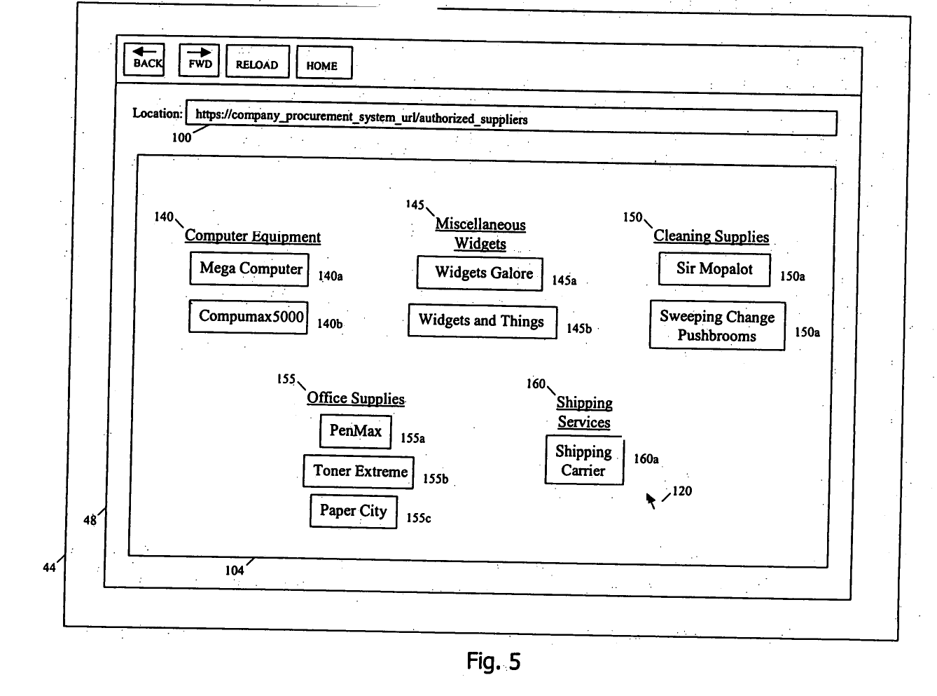

The buyer procurement application responds by sending a log in screen 102 to the buyer interface. The user then types in a username in dialog box 105 and password in dialog box 110 and clicks on the submit button 115 using cursor 120 to authenticate his or her identity to the buyer procurement application. Once the user has been authenticated, the buyer procurement application sends a web page 103 containing text and/or graphics as shown in FIG. 4. The web page allows the user to select a link, or button entitled, for example, “Create a Requisition” 125, that will start the procurement process by creating a requisition. A requisition is an order for needed goods or services. This step starts the online requisition. Later steps will complete it. Other links or buttons may be presented, such as links or buttons that access the user's profile information 130, or links or buttons that allow the user to see purchase histories 135. The “Create a Requisition” link or button is preferably selected by the user moving the cursor 120 over it and clicking a button on a pointing device such as a mouse as is well known in the art. The link or button may alternatively be selected by highlighting the link or button with the keys of a keyboard and pressing the enter key once the link or button is highlighted. After the “Create a Requisition” selection has been made, the buyer procurement application sends a web page 104 to the browser application which displays text and/or graphics representing goods or services available for purchase via the e-procurement process supported by the buyer procurement application. An example of such a web page is depicted in FIG. 5. The data may consist of a scrollable list of suppliers or may present a navigable hierarchical tree of suppliers grouped by type. Whatever its form, the user navigates the list using the input devices of the user interface and selects to purchase shipping services 160 from a shipping carrier. This selection may be made by highlighting a selection and then clicking an execute button or execution may occur upon the selection being made. In the example web page depicted in FIG. 5, execution occurs once the shipping carrier button 160a is selected by placing cursor 120 over it and clicking a button on a pointing device.

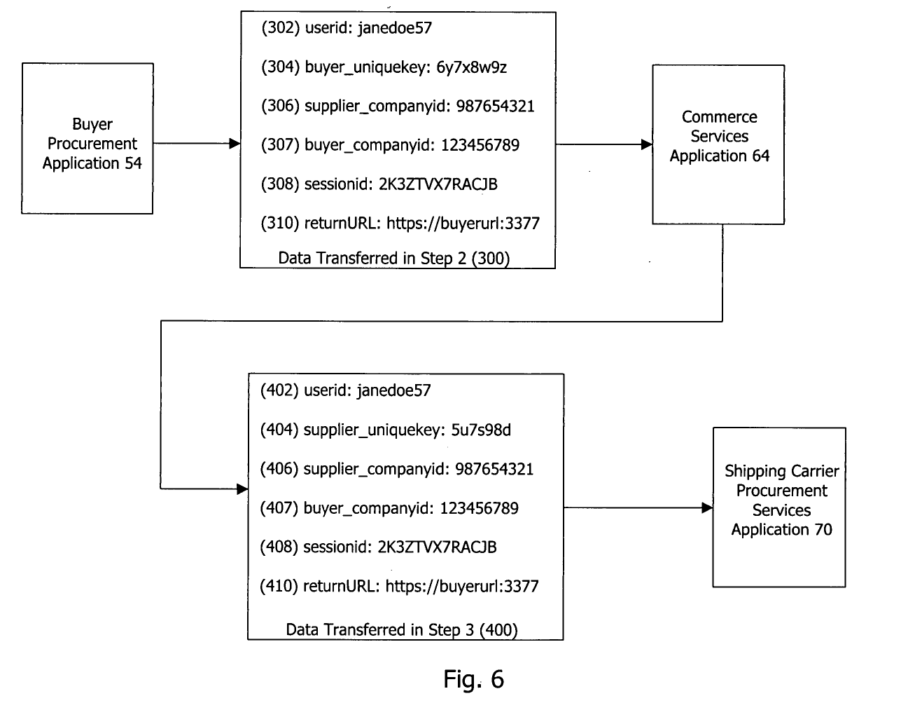

At step 2 shown in FIG. 2, once shipping services have been selected for purchase and the selection has been executed, the buyer procurement application sends a number of data elements to the commerce services application 64 on the commerce services server 62. The data elements are illustrated in FIG. 6. The data sent 300 includes, but is not limited to a user identification string 302 that identifies user attempting to make a purchase, a unique buyer key 304 that has been distributed to the buyer company and stored in the buyer procurement application 54 to verify the authenticity of a purchase request, a supplier company identifier 306 that identifies the supplier company, a buyer company identifier 307 that identifies the supplier company, a session identification string 308 to record and track the progress of the transaction, and a return URL address 310. The user identification string 302 can be the userid entered by the user upon logging into the buyer procurement application in step 1. The unique buyer key 304 can be a unique number distributed to the buyer company by the commerce services provider or the shipping carrier. The purpose of the unique key is to verify that the purchase request is authentic. The company identifier is preferably a Data Universal Number System (DUNS) number. DUNS numbers are nine digit numbers issued by Dun & Bradstreet, Inc. to identify each corporate location of a business.

In one embodiment of the invention, the data sent in Step 2 of FIG. 2 is sent using the commerce extensible markup language (cXML) format. cXML is a protocol intended to facilitate communication of business documents between procurement applications, commerce services applications, and suppliers and is a subset of extensible markup language XML. cXML text can be generated by a common gateway interface (CGI) program or script written in scripting languages such as PERL or programming languages such as C and C++. The cXML protocol is implemented in procurement services products offered by Ariba such as Ariba Buyer. The protocol is also implemented in Ariba's Commerce Services Network. Therefore, in this embodiment, the procurement application 54 preferrably comprises Ariba Buyer software and the commerce services application 64 preferrably comprises the Ariba Commerce Services Network application.

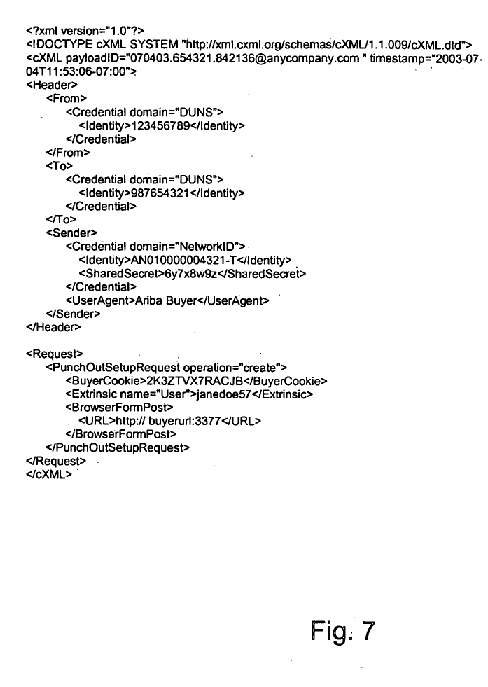

FIG. 7 shows an example of a cXML formatted page that can be used for sending the data elements transferred from the buyer procurement application to the commerce services application in Step 2. Each of the data elements illustrated in FIG. 6 can be transferred using cXML. Referring to the cXML code in FIG. 7, the user identification string 302 of FIG. 6 can be carried in the tag ‘<Extrinsic name=“User”>janedoe57 </Extrinsic>’. The unique buyer key 304 of FIG. 6 used to authenticate the request can be carried in the tag ‘<SharedSecret>6y7x8w9z </SharedSecret>’. The supplier company identifier 306 of FIG. 6 can be transferred using the ‘<To><Credential domain=“DUNS”><Identity>987654321</Identity></Credential></To>’ tag set. The buyer company identification 307 can be contained in the ‘<From><Credential domain=“DUNS”><Identity>123456789</Identity></Credential></From>’ tag set. The session identification string 308 can be transferred in the ‘<Buyercookie>2K3ZTVX7RACJB</Buyercookie>’ tag set. The tag set ‘<BrowserFromPost><URL>http://buyerurl:3377</URL></BrowserFormPost>’ can carry the return URL address 310.

Continuing to Step 3 of FIG. 2, the commerce services application uses the data received in step 2 to lookup profile data stored on the server. If the data is sent using cXML, this step comprises parsing the data to extract the information contained in the tag sets. Using the buyer company identifier 307, the commerce services application searches for a profile corresponding to the buyer company. Once the profile is located, the commerce services application retrieves the profile information and checks the unique buyer key 304 against data stored in the profile to verify the identity of the buyer organization. Using the supplier company identifier 306, the commerce services application searches for and retrieves stored profile information corresponding to the supplier company. The commerce services application retrieves a unique supplier key 404, and a URL for the shipping carrier procurement services server. The commerce services application then forwards the data of Step 2 (300), with the exception of the unique buyer key 304 to the shipping carrier procurement services application 70 at the URL location. The unique supplier key 404 is included instead of the unique buyer key. The data transferred in this step 400 is illustrated in FIG. 6. A cXML document used to complete this data transfer would look similar to that shown in FIG. 7 with at least one exception. This exception is that the string in the ‘<SharedSecret></SharedSecret>’ tag set will be changed from the unique buyer key to the unique supplier key. These keys may also be key identifiers or public keys with corresponding private keys as are well known in the art of network authentication.

An alternative embodiment is also possible wherein the URL for the shipping carrier procurement services server is stored in the buyer procurement application 54. In this embodiment, cXML code such as ‘<SupplierSetup><URL>https://shippingcarrier.com/buyerservices<AURL></SupplierSetup>’ is transferred in the cXML document from the buyer procurement application 54 to the commerce services application 64. In this embodiment, the commerce services application would not need to find the shipping carrier procurement services server URL.

Upon receiving the data 400, the shipping carrier procurement services application verifies that the data was sent by an authorized commerce services network application. This can be done by checking the unique supplier key 404. The shipping carrier procurement services application then determines the identity of the buyer organization using the buyer company identifier 407. The identity of the buyer organization is needed to, for example, send pages with data and pricing customized for the buyer company.

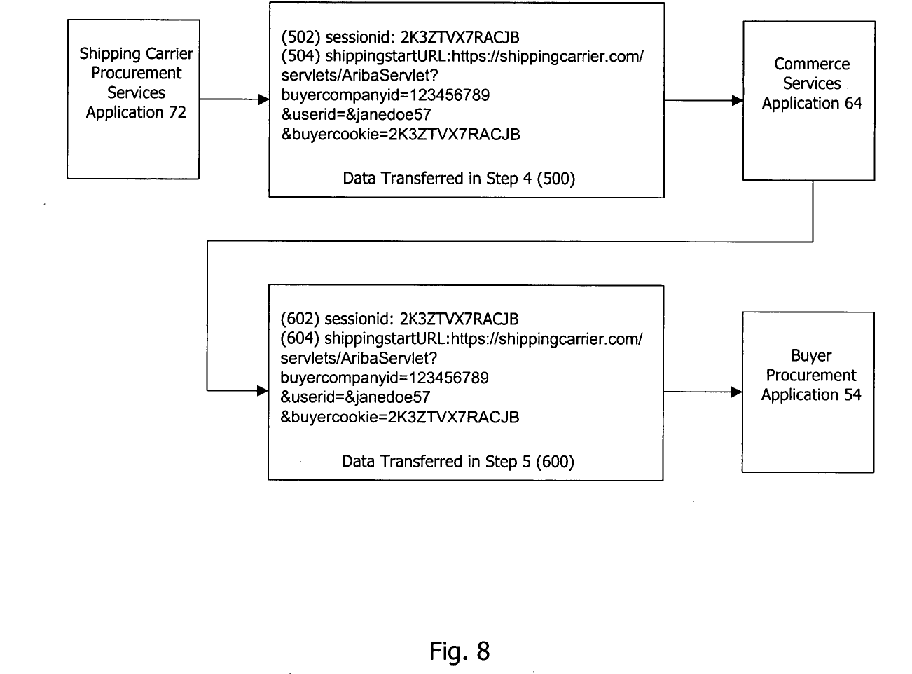

In Step 4 of FIG. 2, the shipping carrier procurement services application sends a response to the commerce services application. The data included in this response is depicted in FIG. 8. The response includes the session identification string 502 used in the previous transactions. This session identification string allows the various applications to track the progress of the transaction. A shipping carrier procurement services startup URL 504 is also sent in the response. The shipping carrier procurement services startup URL is the location on the shipping carrier procurement server that handles procurement requests from procurement applications. Along with the starting location for handling the procurement request, the shipping carrier procurement services startup URL can comprise embedded variables that automate the process of logging a user into the shipping carrier procurement services application. The embedded variables can comprise the buyer company identifier, the user identification string, and the session identification string.

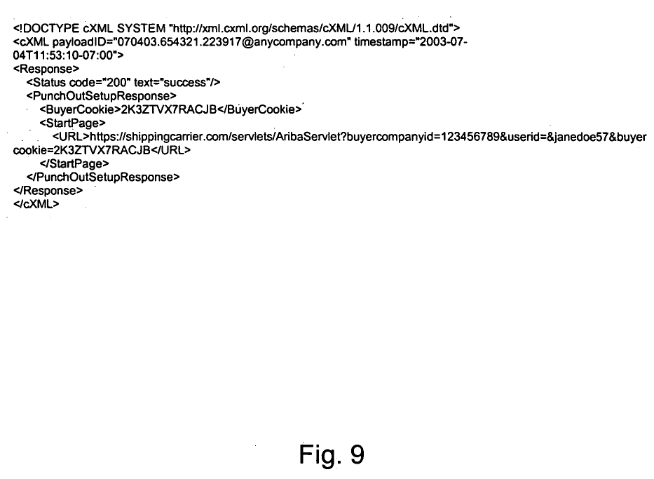

An example of a cXML page that can be used to facilitate the transfer of the data in step 4 (500) of FIG. 8 is shown in FIG. 9. The session identification string can be sent in the ‘<BuyerCookie>2K3ZTVX7RACJB</BuyerCookie>’ tag set. The shipping carrier procurement services startup URL can be transferred in the ‘<StartPage><URL>https://shippingcarrier.com/servlets/AribaServlet?buyerompanyid=123456789&userid=&janedo e57&buyercookie=2K3ZTVX7RACJB</URL></StartPage>’ tag set. The characters following the “?” in the URL are embedded variable/data pairs. They are separated from each other using an “&” symbol. This URL configuration is presented merely as an example, many configurations are possible.

In Step 5 of FIG. 2, the commerce services application forwards the response from the shipping carrier procurement services application to the buyer procurement application 54. The data transferred in step 5 (600) is shown in FIG. 8. The commerce services application can forward the data without modification.

Upon receiving the forwarded response from the commerce services application, the buyer procurement application, In Step 6, opens a new browser window on the buyer interface. The new browser window is pointed to the shipping carrier procurement services startup URL contained in the transferred data 600.

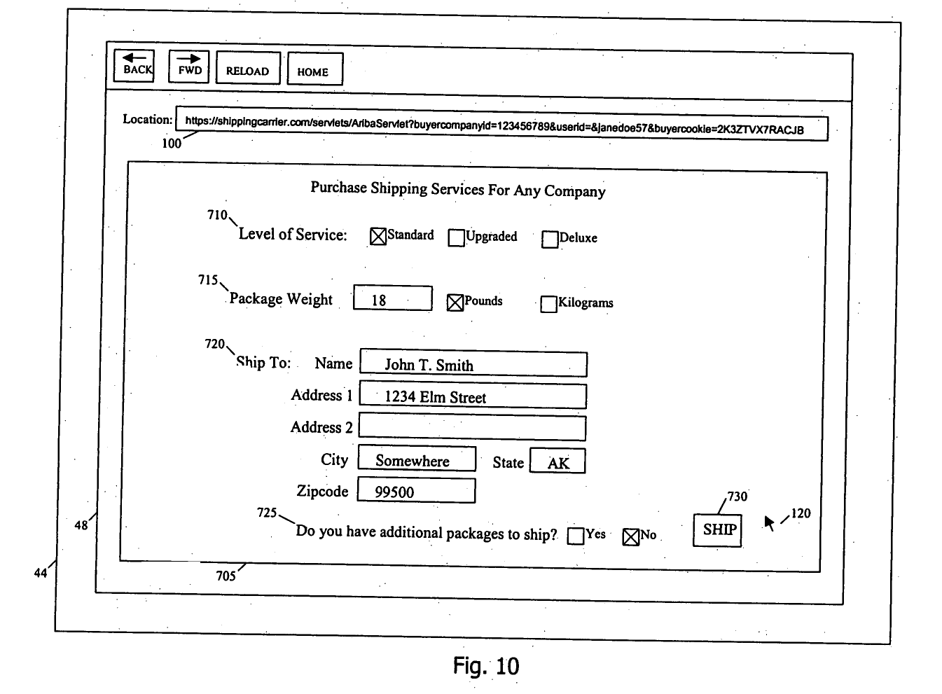

In Step 7, the new browser window opened in Step 6 contacts the shipping carrier services application 72. The shipping carrier procurement services application then sends back a web page 705 as shown in FIG. 10. The web page can have check boxes, radio boxes or the like 710 for the user to indicate the level of desired service. A dialog box for entering the weight of the package to be shipped 715 can be provided and well as dialog boxes for entering the ship to address 720. The web page 705 can include check boxes, radio buttons, or the like 725 for the user to indicate if she has additional packages to ship so that additional shipping services for those additional packages can be purchased through additional web page forms. Once the correct data has been entered, the user selects the “SHIP” button 730. This button is preferably selected by moving the cursor 120 over the “SHIP” button and clicking a mouse or other pointing device. The form data from the web page 705 is then sent to the shipping carrier procurement services application.

The shipping carrier procurement services application collects the data entered by the user into the web page 705. This information along with other information stored in the shipping carrier procurement services server 70 is used to construct a shipping label. Other information that may be used to construct the shipping label can include, but is not limited to, location information stored in the shipping carrier procurement server regarding the buyer organization profile identified by the buyer company identification string discussed previously. For example, the information for a “ship from” address field may be obtained from this profile information.

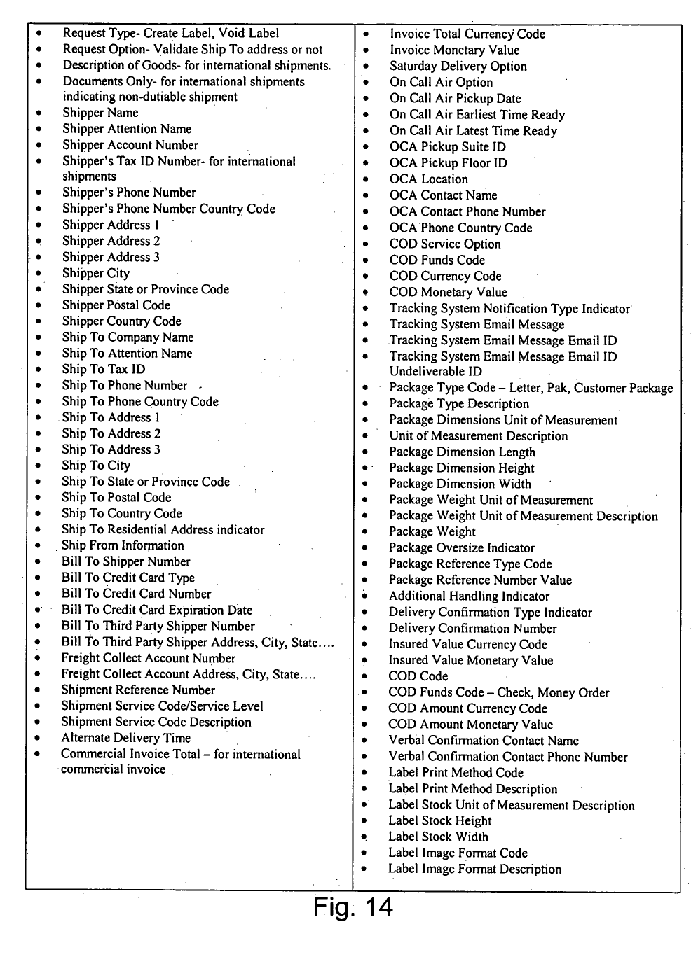

The shipping carrier procurement services application is preferably configured to communicate with the shipping carrier tracking system, and/or the shipping carrier billing system. The information collected from the user along with additional information stored in the shipping carrier procurement services server can be communicated to the shipping carrier tracking system to allow the shipping carrier tracking system to generate a shipping label. The completed shipping label is sent from the shipping carrier tracking system to the shipping carrier procurement services server. The information collected from the user along with additional information stored in the shipping carrier procurement services server can be sent to the shipping carrier billing system to allow the shipping carrier billing system to calculate the shipping charges for shipping services and/or create a bill for the shipping services. A list of information that can be sent from the shipping carrier procurement services server to the shipping carrier tracking system and/or the shipping carrier billing system is shown in FIG. 14. The list is meant for purposes of example only. The actual information sent can include information not shown in FIG. 14 and may not include all of the information shown in the figure.

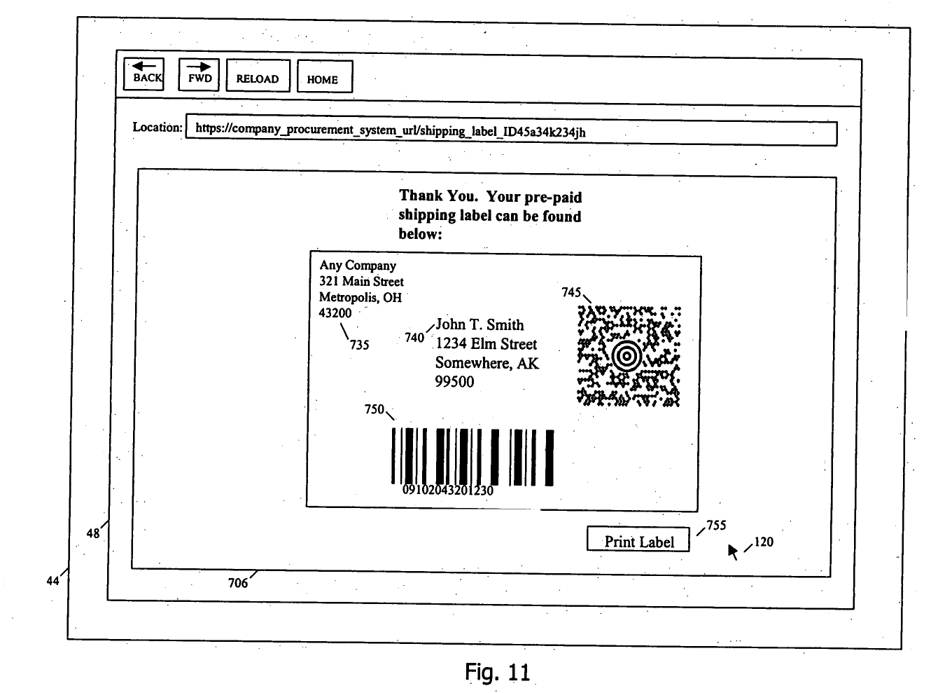

In step 8, the shipping carrier services application 72 sends the completed shipping label 707 to a new browser window 706 on the buyer interface 40 shown in FIG. 11. The label shown in FIG. 11 includes a ship from address 735, ship to address 740, two-dimensional bar code 745, and barcode 750. The label depicted is shown for presentation purposes only. A label sent by the system preferably conforms to standards used by the shipping carrier implementing the system and method of the invention.

The label can be sent in a number of formats. For example, the label can be sent as an Adobe Acrobat file, a Microsoft Word Document, or as an image file. If an image file format is used, such a format can be any of those well known in the art. Once received by the browser application 48, the shipping label can be printed on a printer attached to the buyer interface computer 42 or on a network printer connected to the buyer intranet 50. The shipping label is then attached to the package to be shipped. The printer can optionally print the label on paper having a peel away adhesive backing for easier attachment to the package to be shipped. Some formats for sending the shipping label allow the user to optionally save to the label to a storage device for later printing.

In one embodiment, data included on the shipping label can optionally be sent in a data file along with or instead of the shipping label designed for printing. The data file is formatted to comply with the shipping carrier's standards for radio frequency identification RFID tags. In this embodiment, if the buyer interface computer is equipped with an RFID programming device, an RFID tag can be programmed using the data file. The RFID tag can then be attached to the package to be shipped.

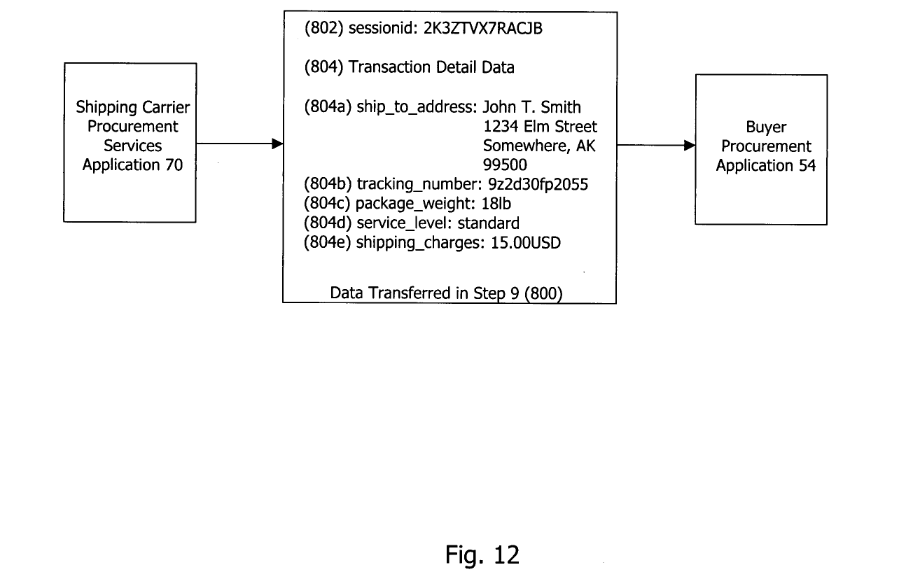

In step 9, after sending the pre-paid shipping label 707 to the buyer interface 40, the shipping carrier procurement services application 72 sends data to the buyer procurement application 54. The shipping carrier procurement services application directs this data to the URL specified in the return URL 310 of Step 2 shown in FIG. 6. FIG. 12 illustrates an example data set 800 that can be sent in step 9 to the return URL. The data can comprise the sessionid 802. This is the same session identification string used throughout the transaction. Providing the session identification string to the buyer procurement server allows the server to match the data from the shipping carrier procurement services server with the initial request sent to the commerce services application along with any corresponding data stored in the buyer procurement server 52. The data 800 sent from the shipping carrier procurement services application to the buyer procurement application in step 9 can further comprise transaction detail data 804. This detail data can include the ship to address 804a, the package tracking number 804b, the package weight 804c, the service level 804d, and the shipping charges 804e.

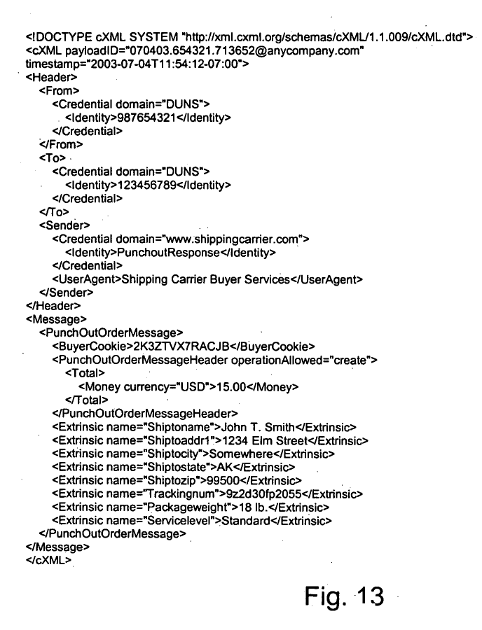

FIG. 13 shows a cXML page that can be used to facilitate the transfer of the data 800. The session identification string 802 can be carried in the ‘<BuyerCookie>2K3ZTVX7RACJB </BuyerCookie>’ tag. The elements of the ship to address 804(a) can be sent in the ‘<Extrinsic name=“Shiptoname”>John T. Smith</Extrinsic>’, ‘<Extrinsic name=“Shiptoaddrl”>1234 Elm Street</Extrinsic>’, ‘<Extrinsic name=“Shiptocity”>Somewhere</Extrinsic>’, ‘<Extrinsic name=“Shiptostate”>AK</Extrinsic>’, ‘<Extrinsic name=“Shiptozip”>99500</Extrinsic>’ tag sets. The tracking number 804b can be sent using the ‘<Extrinsic name=“Trackingnum”>9z2d30fp2055</Extrinsic>’ tag set. The package weight 804c can be sent via the ‘<Extrinsic name=“Packageweight”>18 lb.</Extrinsic>’ tag set. The service level 804d can be sent using the ‘<Extrinsic name=“Servicelevel”>Standard</Extrinsic>’ tag set. The shipping charges 804e can be provided via the ‘<Total><Money currency=“USD”>15.00</Money></Total>’ tag set.

This data is then recorded by the buyer procurement application in a manner similar to the way that the buyer procurement application would record transaction information regarding purchases of commodities made via the procurement system. The data can then be used to create reports and transaction histories. The buyer procurement application preferably provides features that allow purchases to be tracked on business wide, department, and user levels. The system and method therefore provide for the online purchase of shipping services and delivery of prepaid shipping labels integrated in an electronic procurement or spend management system so that the benefits provided by such an electronic procurement or spend management system can be realized.

One embodiment of the invention can omit the commerce services server 62 and commerce services application 64. In this embodiment, steps 2 and 3 shown in FIG. 2 are combined as are steps 4 and 5. Message authentication is handled by the buyer procurement server 52 and the shipping carrier procurement services server 70. The buyer procurement server has the information needed to communicate with the shipping carrier procurement services server to purchase shipping services. The URL location of the shipping carrier procurement services server can be stored in the buyer procurement system so there is no need for a commerce services server to read profile information to retrieve the URL.

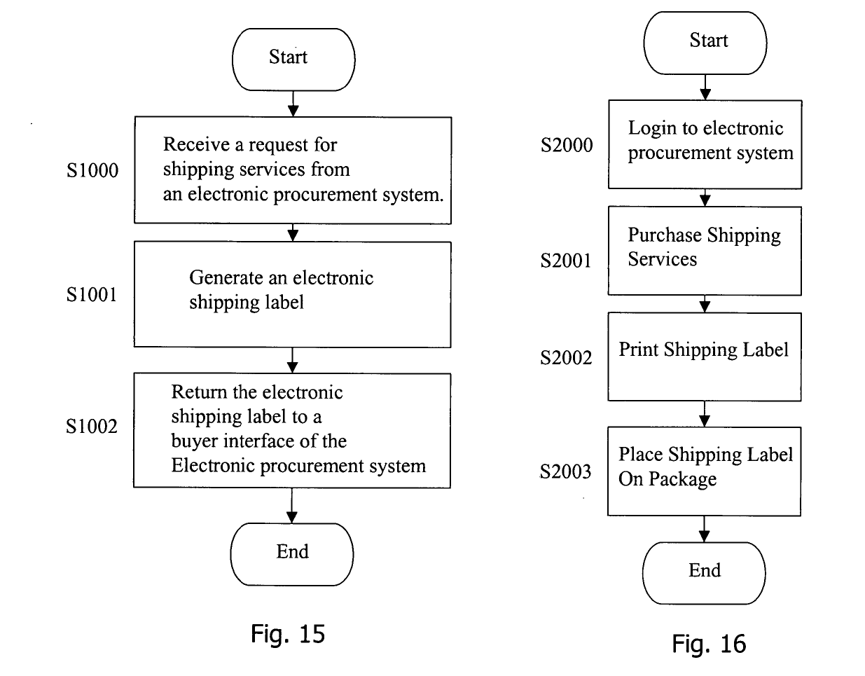

FIG. 15 illustrates the process of providing shipping services according to the present invention. At Step S1000 the shipping carrier accepts a request for shipping carrier services from an electronic procurement system. The request includes a destination address for a package to be shipped and can include the weight of the package, the origin address, the package dimensions, and the level of service desired. At Step S1001 the shipping carrier generates an electronic shipping label. The generated shipping label includes the destination address, and can include the origin address, the package dimensions, the level of service desired. At Step S1002 the shipping carrier returns the electronic shipping label to the buyer interface of the electronic procurement system. The shipping label can be returned in a number of forms including Adobe Acrobat™ or Microsoft Word™ document format. Image files can be used to return the shipping label as well. The format should enable the recipient to print the label so that it can be placed on the package to be shipped.

FIG. 16 illustrates the process of shipping a package according to the present invention. At Step S2000 a user logs in to the electronic procurement system. This step can be performed, for example, by the user pointing a web At Step S2001 the user chooses to purchase shipping services through the electronic procurement system. At Step S2002 the user prints the shipping label, and at S2003 the user places the shipping label on the package. At the end of the process the package is ready to be picked up the shipping carrier.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method of providing shipping services via an electronic procurement system comprising the steps of:
offering shipping services to a user via a buyer interface of an electronic procurement system;
enabling the user to purchase shipping services via the electronic procurement system; and
returning a printable shipping label to the buyer interface.

2. The method of claim 1 wherein the shipping services are outbound shipping services.

3. The method of claim 1 wherein the shipping services are for shipping a package from a location of the user to a second location.

4. The method of claim 1 wherein the shipping services are for shipping a package from the user's location to a second location.

5. The method of claim 1 wherein at least one commodity is offered for sale via the electronic procurement system in addition to the shipping services.

6. The method of claim 1 wherein the electronic procurement system enables an employer of the user to create a list of suppliers from whom the user can make purchases.

7. The method of claim 1 wherein the shipping services are offered at a price negotiated between an employer of the user and a shipping carrier.

8. The method of claim 7 wherein the price is stored in the electronic procurement system.

9. The method of claim 1 wherein the electronic procurement system records purchases made by the user.

10. The method of claim 9 wherein the electronic procurement system records purchases made by an organization within a company of which the user is a member.

11. The method of claim 10 wherein the electronic procurement system is operable to generate reports based on purchases made by the user using the electronic procurement system.

12. The method of claim 11 wherein the reports show purchase data at the organization level.

13. The method of claim 12 wherein the reports show purchase data at the user level.

14. A method of providing shipping services in an electronic procurement system comprising the steps of:
providing a selectable list of suppliers to a user via a buyer interface of an electronic procurement system, at least one of the suppliers being a shipping carrier; and
offering shipping services to the user via the electronic procurement system upon the user selecting the shipping carrier from the list of suppliers.

15. The method of claim 14 further comprising the step of:
enabling the user to purchase shipping services via the electronic procurement system.

16. The method of claim 15 further comprising the steps of:
generating data formatted to program an radio frequency identification (RFID) tag;
returning data formatted to program an radio frequency identification (RFID) tag to the buyer interface.

17. The method of claim 15 further comprising the steps of:
generating a shipping label; and
returning a shipping label to the buyer interface.

18. The method of claim 17 wherein the step of generating a shipping label comprises providing the ship to address, and the level of service to a shipping carrier tracking application.

19. The method of claim 17 wherein the electronic procurement system comprises a buyer procurement server and a shipping carrier procurement services server.

20. The method of claim 19 wherein the electronic procurement system further comprises a commerce services server.

21. The method of claim 19 wherein the step of offering shipping services to the user via the electronic procurement system upon the user selecting the shipping carrier from the list of suppliers comprises the steps of:
sending user data from the procurement server to the shipping carrier procurement services server upon the user selecting the shipping carrier from the list of suppliers; and
sending a startup uniform resource locator from the shipping carrier procurement services application to the buyer procurement application.

22. The method of claim 21 wherein the electronic procurement system further comprises a commerce services server and wherein the step of sending user data from the buyer procurement server to the shipping carrier procurement services server comprises the steps of:
sending user data from the buyer procurement server to the commerce services server; and
sending user data from the commerce services server to the shipping services procurement server.

23. The method of claim 21 wherein the user data comprises:
a user identifier;
a buyer company identifier;
a return uniform resource locator; and
a session identifier.

24. The method of claim 23 further comprising the steps of:
sending transaction data to the buyer procurement server from the shipping carrier procurement services server, the data being sent to location referred to by the return uniform resource locator.

25. The method of claim 23 wherein the user data further comprises:
a unique buyer key; and
a supplier company identifier;

26. The method of claim 25 wherein the user data is sent in XML tags.

27. The method of claim 22 wherein the user data comprises:
a user identifier;
a buyer company identifier;
a return uniform resource locator; and
a session identifier.

28. The method of claim 27 wherein the user data further comprises:
a supplier company identifier.

29. The method of claim 28 wherein the user data further comprises:
a unique buyer key,
and a unique supplier key,
the unique buyer key being sent from the procurement server to the commerce services server and the unique supplier key being sent from the commerce services server to the shipping carrier procurement services server.

30. The method of claim 29 wherein the user data is sent in XML tags.

31. The method of claim 21 wherein the startup uniform resource locator contains embedded values.

32. The method of claim 31 wherein the embedded values comprise a user identifier, a buyer company identifier, and a session identifier.

33. The method of claim 21 wherein the step of enabling the user to purchase shipping services via the electronic procurement system comprises:
directing a browser application on the buyer interface to the startup uniform resource locator.

34. The method of claim 33 wherein the step of enabling the user to purchase shipping services via the electronic procurement system further comprises:
enabling the user to specify package shipping data including a ship to address, a package weight, and a level of service.

35. A method of providing shipping services comprising the steps of:
providing a selectable list of suppliers to a user logged in to an electronic procurement application, at least one of the suppliers being a shipping carrier;
offering shipping services to the user upon the user selecting the shipping carrier from the list.

36. A method of providing shipping services comprising the steps of:
receiving a request for shipping services made from a buyer interface of an electronic procurement system; and
returning a shipping label to the buyer interface.

37. A method of shipping a package comprising
purchasing shipping services via an electronic procurement system.

38. A system for providing shipping services comprising:
a buyer interface communicatively connected to a network;
a buyer procurement server communicatively connected to the network, the buyer procurement server configured to offer shipping services to a user accessing the buyer interface; and
a shipping carrier procurement services server communicatively connected to the network, the shipping carrier procurement services server being configured to respond to a request for shipping services from the user by sending an electronic shipping label to the buyer interface.

39. The system of claim 38 further comprising:
a commerce services server communicatively connected to the network, the commerce services server configured to accept a request for shipping services from the buyer procurement server and forward that request to the shipping carrier procurement services server.

40. A system for providing shipping services comprising:
a shipping carrier procurement services server configured to receive a request for shipping services made from a buyer interface of an electronic procurement system and configured to generate and return an electronic shipping label to the buyer interface.

41. The system of claim 40 further comprising;
a shipping carrier tracking application configured to accept a request for a shipping label from the shipping carrier procurement services server, generate a shipping label, and send the shipping label to the shipping carrier procurement services server.

42. The system of claim 40 wherein the shipping carrier procurement services server is configured to send a total amount for shipping services to a buyer procurement application.

43. The system of claim 42 further comprising:
a shipping carrier billing application configured to accept a request for a total shipping amount from a shipping carrier procurement services server, calculate a total shipping amount, and send the total shipping amount to the shipping carrier procurement services server.

44. The system of claim 40 wherein the shipping carrier procurement services server is configured to send a startup uniform resource locator to the buyer interface upon the server receiving the request for shipping services.

45. The system of claim 40 wherein the shipping carrier procurement services server is configured to receive package shipping data from the buyer interface.

46. The system of claim 45 wherein the electronic shipping label returned to the buyer interface includes one or more elements of the package shipping data.
